(19) United States
(12) Patent Application Publication
(10) Pub. No.: US 2008/0041191 A1
(43) Pub. Date: Feb. 21, 2008

(54) TUBULAR WRENCH

(76) Inventor: Erin McDermott, Wixom, MI (US)

Correspondence Address: KOHN & ASSOCIATES, PLLC, 30500 NORTHWESTERN HWY, STE 410, FARMINGTON HILLS, MI, 48334, US

(21) Appl. No.: 11/838,373

(22) Filed: Aug. 14, 2007

Related U.S. Application Data
(60) Provisional application No. 60/837,716, filed on Aug. 15, 2006.

(51) Int. Cl. B25D 1/16

(52) U.S. Cl. 81/27

(57) ABSTRACT

A tubular wrench adapted for firmly engaging a connection fitting, including a cylindrical, hollow outer sleeve having an outer sleeve head located on at least one end of the outer sleeve, a cylindrical, hollow inner sleeve having an inner sleeve head located on at least one end of the inner sleeve, wherein the inner sleeve is passed through the outer sleeve, allowing the inner sleeve to connect to the lower end of a desired connection fitting while the outer sleeve connects to the upper end of a desired connection fitting. Methods of assembling and disassembling a connection fitting with the tubular wrench.

### CROSS-REFERENCE TO RELATED APPLICATIONS

This application claims the benefit of priority under 35 U.S.C. Section 119(e) of U.S. Provisional Patent Application No. 60/837,716, filed Aug. 15, 2006, which is incorporated herein by reference.

### BACKGROUND OF THE INVENTION

(1) Field of the Invention

The present invention generally relates to the field of wrenches. More specifically, the present invention relates to a tubular wrench for use in tight spaces.

(2) Description of Related Art

Plumbers, mechanics, homeowners, carpenters, maintenance workers and tradespersons in many industries commonly use connectors to attach two members together. Often, such connectors are located in hard-to-reach spaces with limited working space near the connector. Also, such connectors may be used in combination with a linear member, such as a water line in plumbing or a brake line in automotive mechanics. Particularly in performing maintenance, a tradesperson may encounter a connector, which was easy to reach during the initial installation of the connector, but has become hard-to-reach due to the subsequent installation of an intervening object.

For example, in plumbing, when a sink or lavatory is first installed, the water lines are attached with connectors before installation of the basin. Prior to installation of the basin, the connectors attaching the water line to the sink or lavatory is easy to reach; however, after installation of the basin, a small space is left between the basin and the cabinet or wall. Common plumbing tasks, such as repairing or replacing a faucet, require the removal and reattachment of these water lines. Because removal of the basin is time-consuming and impractical, the only way to access the connector attaching the water line to the sink or lavatory is by approaching the connector from below through a tight space. Due to the presence of the water line, the actual engagement with the connector can only happen from the side. The space to either side of the connector is often insufficient in size to allow the use of a conventional wrench. Often, only a few inches of horizontal space remain within which to maneuver a tool for this task.

Similarly, in automotive mechanics, a common task is removal and reattachment of a gas line or a brake line, which involves a linear member attached with a connector at one end of the line. As with plumbing, there is often limited space to allow use of a conventional wrench.

Various tools have been devised to access connectors in hard-to-reach spaces. Many of these tools typically include engaging ends with multiple parts and a large cross-sectional area when measured in a direction perpendicular to the axis of the tool. The large cross-sectional area leads to numerous problems. For example, many of these tools have multiple parts, making them expensive to manufacture and easy to damage or break. Furthermore, the difficulty in using these tools often leads to the user becoming fatigued and prone to injure their knuckles or hands during operation of the tool.

For example, U.S. Pat. No. 4,485,702 to Swan et al. generally discloses a basin wrench having a telescoping handle and a spring loaded movable jaw for clamping a nut or pipe against a gripping face. The movable jaw and gripping face may be rotated about a shaft. The '702 patent also discloses a positive action basin wrench with additional features and an even bulkier and more complicated engaging end. While effective, both wrenches have engaging ends with multiple parts. These engaging ends have large cross-sectional areas when measured in a direction perpendicular to the axis of the tool that are difficult to use in tight spaces. Due to the complexity of the tools, they are expensive to manufacture and not very durable.

Numerous other devices have been developed pertaining to single piece wrenches for use in tight spaces. Examples of such patents include U.S. Pat. Nos. 5,035,162 to Dougherty, 5,542,321 to Fuca, 5,996,447 to Bayouth, and 6,257,099 to Rosenbaum; and United States Patent Application Publication Number 2005/0199103 to Thompson, et al., all of which disclose tubular wrenches formed of single hollow sleeves or pipes. The primary difficulty with such devices is that they can easily disengage the part that is intended to be affixed.

It would therefore be useful to develop a tubular device for use in affixing nuts or similar devices that do not easily disengage the device being affixed.

### SUMMARY OF THE INVENTION

According to the present invention, there is provided a tubular wrench adapted for firmly engaging a connection fitting, including a cylindrical, hollow outer sleeve having an outer sleeve head located on at least one end of the outer sleeve, a cylindrical, hollow inner sleeve having an inner sleeve head located on at least one end of the inner sleeve, wherein the inner sleeve is passed through the outer sleeve, allowing the inner sleeve to connect to the lower end of a desired connection fitting while the outer sleeve connects to the upper end of a desired connection fitting.

The present invention also provides for a method of assembling a connection fitting using the tubular wrench by attaching the outer sleeve to an upper end of a connection fitting, passing the inner sleeve through the inner bore of the outer sleeve, attaching the inner sleeve to a lower end of the connection fitting, applying a force to the outer sleeve and an opposing force to the inner sleeve, and assembling the connection fitting.

The present invention further provides for a method of disassembling a connection fitting using the tubular wrench by attaching the outer sleeve to an upper end of a connection fitting, passing the inner sleeve through the inner bore of the outer sleeve, attaching the inner sleeve to a lower end of the connection fitting, applying a force to the outer sleeve and an opposing force to the inner sleeve, and disassembling the connection fitting.

### DESCRIPTION OF THE DRAWINGS

Other advantages of the present invention are readily appreciated as the same becomes better understood by reference to the following detailed description, when considered in connection with the accompanying drawings wherein;

FIG. 1 is a side view of the device of the present invention in use;

FIG. 2 is a side view of the disassembled device of the present invention; and

FIG. 3 is an enlarged side view of the device of FIG. 1.

### DETAILED DESCRIPTION OF THE INVENTION

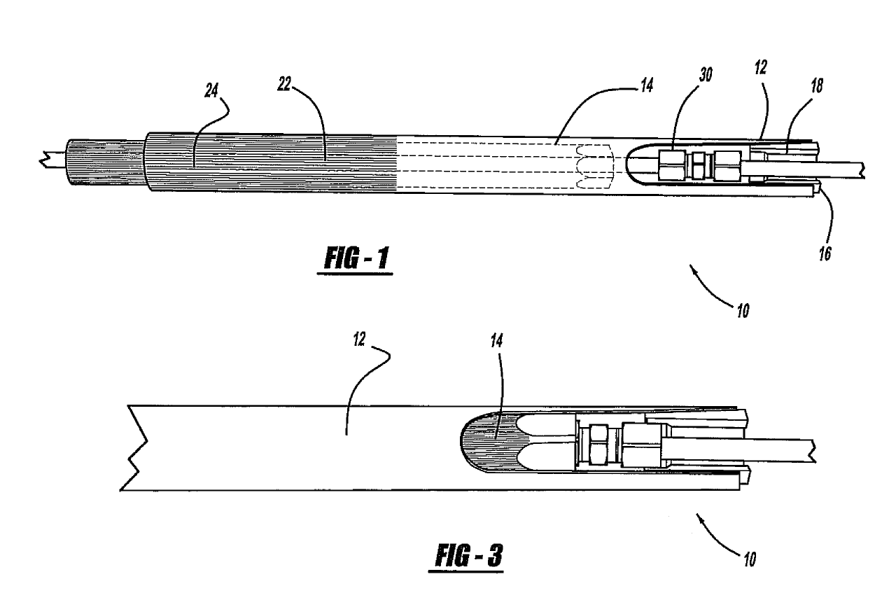

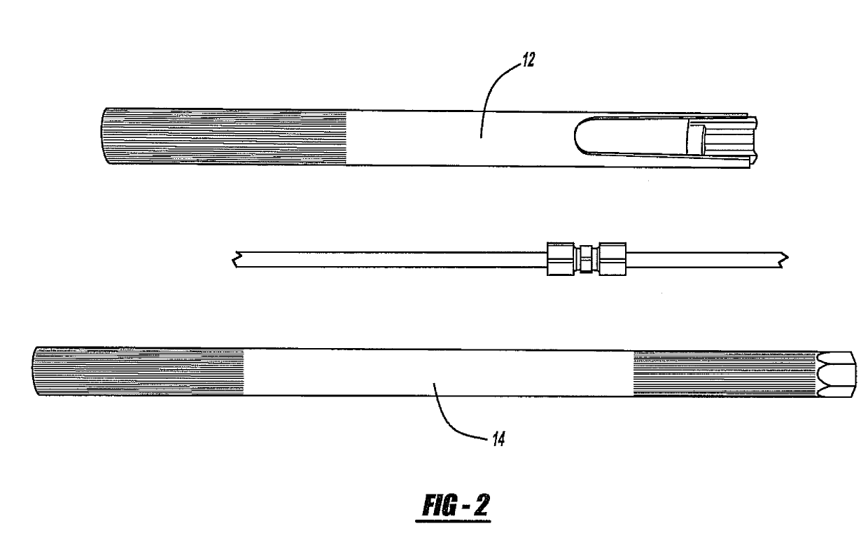

Generally, the present invention provides a two-piece tubular wrench (10) that includes an outer (12) and an inner (14) sleeve, as shown in FIGS. 1-3. The wrench (10) is used to apply force to a fitting in order to affix the fitting in the appropriate position.

The wrench (10) of the present invention can be formed of any rigid material capable of withstanding the pressure or force required to affix a fitting in position. Examples of such materials include, but are not limited to, rigid plastics, metals, and other similar material known to those of skill in the art.

The wrench (10) according to the present invention can be sized to fit the desired use. In other words, the wrench (10) can be made small or large, or of any other size as required for the desired use. For example, if the wrench (10) is intended to be used for plumbing, the wrench (10) can be approximately 18 inches long and the outer sleeve (12) can have approximately a ½ inch diameter and the inner sleeve (14) can have a smaller diameter than the outer sleeve to enable the inner sleeve (14) to easily fit within the outer sleeve (12). Preferably, the wrench (10) is straight, but curved versions of the wrench (10) can also be utilized without departing from the spirit of the present invention.

The outer sleeve (12) is a hollow tube, forming an inner bore, including an outer sleeve head (16) operatively connected to at least one end of the outer sleeve (12). The outer sleeve head (16) is shaped to fit the assembly (i.e. pipe or other fixture) to which the fitting is to be affixed. The outer sleeve head (16) can also include a lip (18). The lip (18) is a piece of material that attaches to the assembly but has a smaller diameter than the outer sleeve (12). The benefit of the lip (18) is that the outer sleeve (12) can be attached to the assembly and once engaged, the lip (18) prevents the outer sleeve (12) from disengaging. The outer sleeve head (16) also includes an opening (20) on one side of the outer sleeve head (16), as shown in FIGS. 1-3. The opening (20) enables the outer sleeve (12) to be placed in position in a tight space. The outer sleeve (12) further includes a handle (22) on an end opposite the head (16). The handle (22) can be a separate piece such as a piece of plastic that fits over the wrench (10) or it can be machined into the outer sleeve (12). When the handle (22) is machined into the outer sleeve (12) the handle (22) can include striations (24) that assist in maintaining a firm grip on the outer sleeve (12).

The inner sleeve (14) is a hollow tube including an inner sleeve head (26) located on at least one end of the inner sleeve (14). The inner sleeve head (26) is shaped to fit the fitting that needs to be affixed. The inner sleeve (14) can also include a second inner sleeve head (28) at the opposite end of the inner sleeve (14). If the second inner sleeve head (28) is included, it is of a different size than that of the inner sleeve head (26) so that the second inner sleeve head (28) can be used to engage a different sized fitting. Alternatively, the inner sleeve (14) can include a head changing device for allowing the inner sleeve head (26) to be removed and replaced with a separate head. This enables the inner sleeve (14) to be used for an infinite number of different sized fittings. The inner sleeve (14) is smaller in diameter and is preferably longer than the outer sleeve (12).

Both the outer sleeve (12) and inner sleeve (14) can include telescoping devices or other similar devices for extending the length of each sleeve. The attachment of the lengthening device is accomplished without limiting the use of the wrench (10). In other words, it is preferred that the lengthening device not be screwed on since this limits the type of torque that can be applied to the wrench (10).

The wrench (10) of the present invention can also include lights or other attachments for aiding in the use of the wrench (10). For example, the outer sleeve (12) can include a guide on the outer sleeve head (16) for assisting the user in locating the assembly and maneuvering the assembly to the center of the wrench (10).

The fittings to which the wrench is applied can be any shape. For example, the fitting can be hexagonal such as a standard nut. When the nut is twisted using the wrench of the present invention, the nut is secured in place. Alternatively, the fitting can be a cam lock that is held in place by the wrench and then fitted into a specific slot or opening in the assembly.

In use, the outer sleeve (12) is attached to the upper end of a connection fitting assembly. The outer sleeve head (16) is engaged with the upper end of the connection fitting assembly. The lip (18) of the outer sleeve head (16) can also be engaged to the assembly to prevent disengagement of the outer sleeve (12). The inner sleeve (14) is passed through the inner bore of the outer sleeve (12) and the inner sleeve head (26) is engaged with the lower end of the connection fitting. Force is applied by a user to the outer sleeve (12), and preferably to the handle (22), while an opposite force is applied to the inner sleeve (14). The opposing forces cause the assembly or disassembly of the connection fitting. The alignment of the two sleeves (12) and (14) allows the user to apply opposite forces to the connection fittings and effectively assemble or disassemble the fitting as desired and to lock the wrench (10) in place prior to applying force to the wrench (10).

The tool is useful in assembly and disassembly of fittings. With disassembly there is often difficulty in loosening the fitting components and the work done often results in peripheral damage (bent plumbing lines) when using tools that work perpendicular to the longitudinal axis of the fittings. This tubular wrench allows fittings in need of repair to be disassembled without the errant transfer of torque that results in kinked, restricted or broken plumbing lines due to their inherent compliance because of the materials used in their construction (soft copper).

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

What is claimed is:

1. A tubular wrench adapted for firmly engaging a connection fitting, the wrench comprising:
a cylindrical, hollow outer sleeve, said outer sleeve including an outer sleeve head located on at least one end of said outer sleeve;
a cylindrical, hollow inner sleeve, said inner sleeve including an inner sleeve head located on at least one end of said inner sleeve;
wherein said inner sleeve is passed through said outer sleeve, allowing said inner sleeve to connect to the lower end of a desired connection fitting while said outer sleeve connects to the upper end of a desired connection fitting.

2. The tubular wrench of claim 1, wherein said outer sleeve head is shaped to fit said connection fitting upon which said wrench is being used.

3. The tubular wrench of claim 2, wherein said outer sleeve head includes a lip to prevent the disengagement of said outer sleeve.

4. The tubular wrench of claim 3, wherein said lip is of a smaller diameter than said outer sleeve to prevent the disengagement of said outer sleeve.

5. The tubular wrench of claim 2, wherein said outer sleeve head further includes an opening on one side of said outer sleeve head, thereby enabling said outer sleeve to properly engage said connection fitting in tight spaces, and allowing for the feeding of items through said opening.

6. The tubular wrench of claim 1, wherein said outer sleeve further includes a fitted handle on an end opposite said outer sleeve head for maintaining a firm grip of said outer sleeve.

7. The tubular wrench of claim 1, wherein said outer sleeve further includes engraved striations on an end opposite the assembly head for maintaining a firm grip of said outer sleeve.

8. The tubular wrench of claim 1, wherein said outer sleeve further includes a telescoping device for extending the length of said outer sleeve.

9. The tubular wrench of claim 1, wherein said inner sleeve is a hollow cylindrical body, said body having a diameter less than the inner diameter of said outer sleeve, allowing said inner sleeve to fit inside said outer sleeve.

10. The tubular wrench of claim 1, wherein said inner sleeve head is shaped to fit said connection fitting upon which said wrench is being used.

11. The tubular wrench of claim 1, wherein said inner sleeve further includes a second inner sleeve head located at an opposite end of the inner sleeve from said inner sleeve head.

12. The tubular wrench of claim 11, wherein said second inner sleeve head is of a different size than said inner sleeve head.

13. The tubular wrench of claim 1, wherein said inner sleeve further includes a head changing device for removing and replacing said inner sleeve head of said inner sleeve.

14. The tubular wrench of claim 1, wherein said inner sleeve further includes a telescoping device for extending the length of said inner sleeve.

15. The tubular wrench of claim 1, further including a guide light for improved visibility during use of said wrench.

16. A method of assembling a connection fitting using the tubular wrench of claim 1, including the steps of:
attaching the outer sleeve to an upper end of a connection fitting,
passing the inner sleeve through the inner bore of the outer sleeve;
attaching the inner sleeve to a lower end of the connection fitting;
applying a force to the outer sleeve and an opposing force to the inner sleeve; and
assembling the connection fitting.

17. The method of claim 16, wherein said attaching the outer sleeve step is further defined as engaging the outer sleeve head with the upper end of the connection fitting.

18. The method of claim 17, wherein said attaching the outer sleeve step further includes engaging the lip of the outer sleeve head with the upper end of the connection fitting.

19. The method of claim 17, wherein said attaching the inner sleeve step is further defined as engaging the inner sleeve head with the lower end of the connection fitting.

20. A method of disassembling a connection fitting using the tubular wrench of claim 1, including the steps of:
attaching the outer sleeve to an upper end of a connection fitting;
passing the inner sleeve through the inner bore of the outer sleeve;
attaching the inner sleeve to a lower end of the connection fitting;
applying a force to the outer sleeve and an opposing force to the inner sleeve; and
disassembling the connection fitting.

21. The method of claim 20, wherein said attaching the outer sleeve step is further defined as engaging the outer sleeve head with the upper end of the connection fitting.

22. The method of claim 21, wherein said attaching the outer sleeve step further includes engaging the lip of the outer sleeve head with the upper end of the connection fitting.

23. The method of claim 21, wherein said attaching the inner sleeve step is further defined as engaging the inner sleeve head with the lower end of the connection fitting.
